(19) United States
(12) Patent Application Publication
(10) Pub. No.: US 2013/0317997 A1
(43) Pub. Date: Nov. 28, 2013

(54) METHOD AND SYSTEM FOR USE OF AN APPLICATION WHEEL USER INTERFACE AND VERIFIED ASSESSMENTS IN HIRING DECISIONS

(71) Applicant: Preston Leigh Sjoblom, Great Falls, VA (US)

(72) Inventor: Preston Leigh Sjoblom, Great Falls, VA (US)

(73) Assignee: JPMS INC, Reston, VA (US)

(21) Appl. No.: 13/904,016

(22) Filed: May 28, 2013

Related U.S. Application Data
(60) Provisional application No. 61/651,700, filed on May 25, 2012.

(51) Int. Cl. G06Q 10/10; G06F 3/0481

(52) U.S. Cl. CPC G06Q 10/1053; G06F 3/04817
USPC 705/321; 715/834

(57) ABSTRACT

A method and system are disclosed for using verified assessments of employee capabilities in hiring decisions, where the method and system are implemented via applications displayed as icons on a rotatable wheel structure. The verified assessments are of criteria applicable to a group of employees, where the criteria are weighted in accordance with attributes of the group and the hiring decisions depend upon the weighted criteria applied to the assessments of the employee and upon a rating of the group. An arc of the wheel structure is displayed, exposing a subset of applications, the wheel structure being rotatable to expose additional applications within the displayed arc.

### BACKGROUND OF THE INVENTION

1. Field of the Invention

The present invention generally relates to techniques for gathering and using information and more particularly to techniques for gathering and using information in making hiring decisions.

2. Background Description

In a world where no one reads anything anymore—we make judgments on what we see! And we want the information to be visual whenever it can be—if it isn't we'll scan the content and make a call in seconds if the time needed to fully take in the information is warranted. How often did we get it right?—Wrong? Soon we can make it right, when it comes to hiring, when much less will be based on the exercise of an interview

What if the past employers of your candidate told you all about them? Highlighted their strengths, fairly indicated where they are not as strong—reassured you about their attitude under pressure, in a team setting, in a solo setting, with mistakes, with success?

How many countless hours are spent banking the interview process? In some situations an interview process may include one or two telephone interviews for thirty minutes each and several hour long face-to-face interviews. The interview process is time consuming and may not accurately determine relative performance capabilities of candidates.

What is needed is a visually based system and process for connecting candidates to employers, a process that efficiently leverages past experience.

### SUMMARY OF THE INVENTION

It is therefore an object of the present invention to provide a system and methodology for connecting candidates to employers by efficiently leveraging past experience.

The present invention comprises the gathering of evaluations from past employers of whatever kind, respective to the individuals' career, and taking those evaluations into an algorithmic formula that assigns custom weights to the various criteria, specialized to the job, in ways that then offers the most meaning information to a potential employer, because the potential candidate has numeric ranking and rating—meaningful intelligence about the candidate that the employer can rely upon to make the hiring decision without an interview.

The invention is implemented on an Internet web site where individuals showcase their accomplishments, history, experience, education, abilities, prowess, for their careers along with and—most importantly—by becoming vouched for by past employers who have been requested to respond to a questionnaire based on criteria which aims to prove their rating grade to the hiring agents around the world in every job market.

The invention relies upon an Internet web site where companies can review the reliably acquired assessments of the individual so that narrowing down onto truly qualified options to fill the job requirement at their organization is immediate and free.

The verified assessment of candidates assembled at the web site provides companies around the world the ability to either hire local or outsource to their facilities however they want and to shop the assets available to them through robust and powerful informative tools. These tools of the inventive system are simple to use, so that the hiring process can be accomplished in minutes.

The overall accomplishment of this site is to rank and rate the entire workforce of the world for immediate access to any organization with an account.

In one aspect of the invention verified assessments of employee capabilities are obtained with respect to a plurality of performance criteria, which are weighted in accordance with a job description group to which the employee belongs. The weighted performance criteria are applied to the verified assessments, and to this is added a rating of the group, which in combination are used to make a hiring decision.

In another aspect of the invention icons of computer applications used in the hiring decision process are arranged along a perimeter of a wheel structure. An arc of this perimeter is displayed, exposing a subset of the applications. The wheel structure is rotated, thereby exposing additional applications within the displayed arc, and then the icons are rearranged so that those applications most often used are in the displayed arc.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic flowchart showing user account types and the user registration process.

FIG. 2 is a process flow diagram showing user access to applications via an applications wheel.

FIG. 3 is a visual representation of an applications wheel.

FIG. 4 is an exemplar diagram of a web site visual display of criteria for finding candidates.

FIGS. 5A, 5B and 5C are exemplar dashboard displays showing in schematic form statistical data regarding job markets and job candidates; FIG. 5A is a pie chart display of candidates by expected salary range; FIG. 5B is a bar chart of job market attrition rate analysis in a specific sector; FIG. 5C is a graph of the number of available candidates by years of experience.

### DETAILED DESCRIPTION OF A PREFERRED EMBODIMENT OF THE INVENTION

The target audiences for the website built in accordance with the invention are employees, students and the human resources (HR) staffs of employers.

The website helps employees to showcase their skill sets to the HR world (Employers) using the comprehensive information gathering, evaluation and display techniques assembled by the invention. It will allow employees to seek genuine assessments from their former/current peers and supervisors. And these assessment scores are summed up for each employee to rate the employee with a performance score. The performance score is calculated by an algorithm which can compare the score with other individuals in same industry. An employee can improve his/her performance score over time by using the invention to project their accomplishments to the HR world, gaining experience, seeking more reviews, participating in charity projects and other resume rounding activities, and otherwise using the tools provided by the invention. For example, employees can get background checks completed on this website and display it on their profile. And employees are able to search through available job openings for those of particular interest.

The website will guide students through a career path. A website application studies the interests of a student and recommends various classes and courses which help the student to reach their career goals.

The website helps HR to effectively track talented employees using business intelligent search criteria. The reviews provided through the invention will enable HR to find ‘available’ employees and identify the right candidate by looking at their vouched4 profile. HR will also have access to the latest business intelligence reports which can be used to study current job market trends, employee distribution reports and the like.

On the marketing side, businesses can use this new website to post their ads and these ads will be displayed to the user based on relevance. For example, a student will see ads from a nearby college recommending certain classes in areas of interest to reach the student's career goals. The website will also provide a very good market place for business to sell their products to customers not only based on user choice but also because the website helps business to target the users who actually want to buy the product.

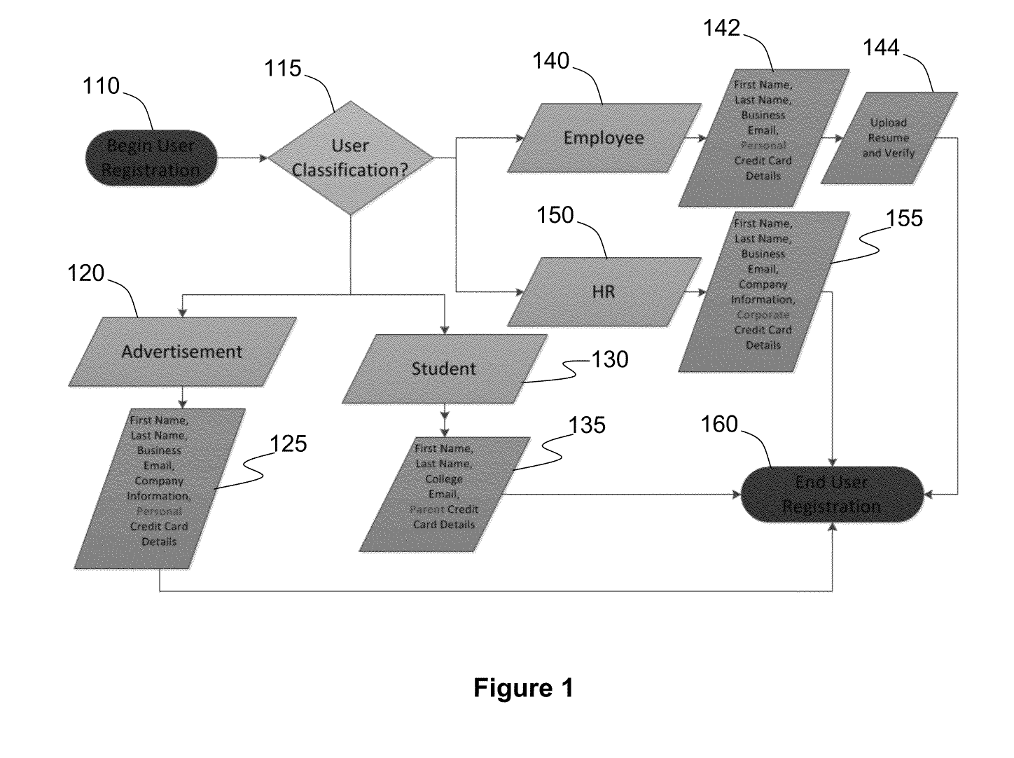

As shown in FIG. 1, user registration 110 requires each user to provide first and last name and relevant email address after a user classification 115 is made. Employee user 140 will in addition provide 142 personal credit card details and then upload and verify a resume 144 before completing registration 160. HR user 150 will in addition provide 155 company information and corporate credit card details before completing registration 160. The student user 130 provides 135 their college email address and in most cases the relevant credit card details will come from parents. The marketing user 120 will also provide 125 company information and corporate credit card details.

Note that credit card details from the user can be verified to ensure that user is indeed providing accurate personal details on the website. The credit card will be charged $1 for the registration fee thirty days after the registration date.

### Process Flow Narration for Employees and Students

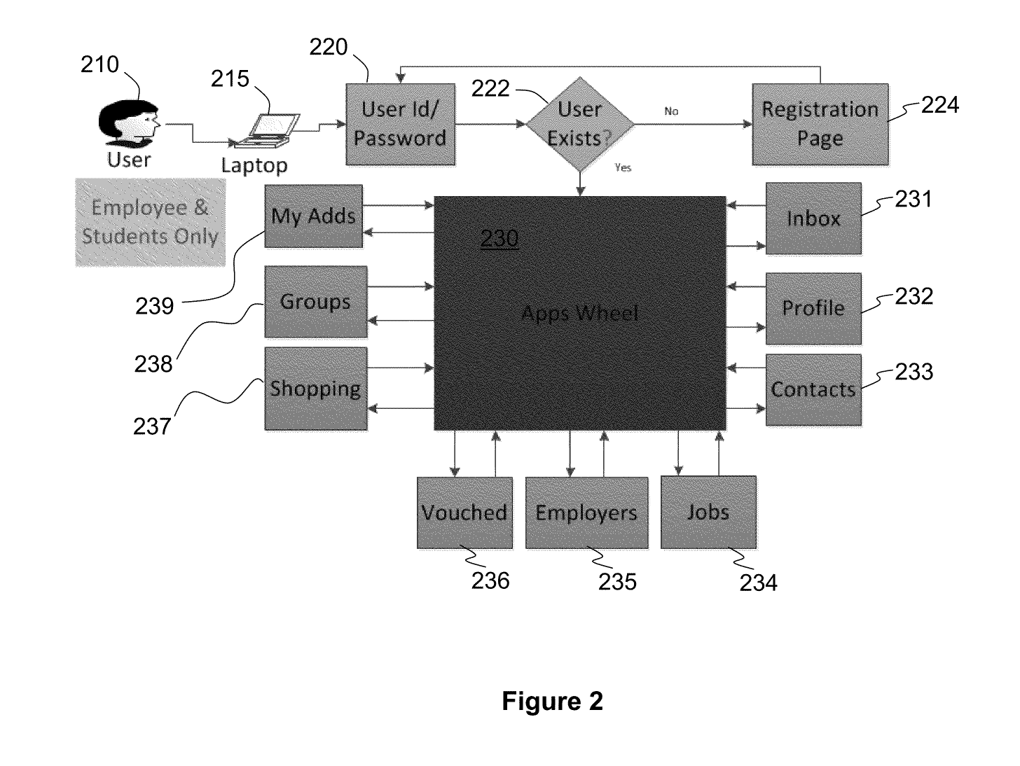

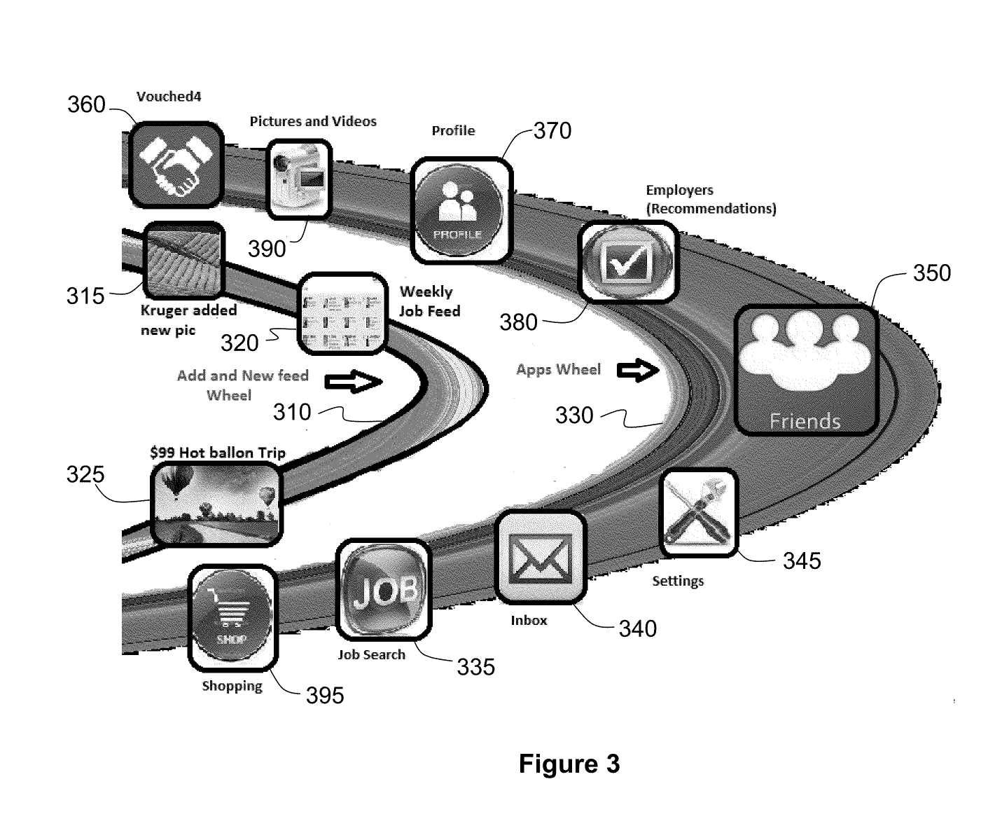

Within the user interface, the application wheel shown in FIG. 3 will take up about 70% of the screen the employee or student user sees. A block diagram of the structure of the user interface is shown in FIG. 2. User 210 accesses the system via an Internet connected device such as a laptop computer 215 and logs on 220 with a user identification (ID) and password. The system checks to see whether the user exists 222, and if the user ID and password combination are not supplied or are not in the system sends the user 210 to a registration page 224 for completion of the user registration process shown in FIG. 1, and then back to the login screen 220.

After confirmation 222 of registration the user 210 enters the application wheel 230. The user interface places all the site navigation behind category organized applications (‘apps’) like: Profile 232; Contacts 233; Groups 238; Employers 235; Vouched 236; Jobs 234; Inbox 231; Shopping 237; and My Ads 239. Additional apps (not shown in FIG. 2) are added to Apps Wheel 230 in similar fashion. These additional apps can provide capabilities directly related to connecting users with employers, or capabilities related to, or usable with, user networks of friends and contacts indirectly related to connecting users with employers. These include Job Search (item 335 on FIG. 3), Activity Map (a business intelligence app), Photos (e.g. Pictures and Videos 390), Education (an app to document education), Jobs (past jobs—bids on future), Resume, Friends (item 350 on FIG. 3) and Evaluations.

Turning more directly to FIG. 3, the functionality of Apps Wheel 330 is such that the user turns or rotates the wheel to access the apps that are not visible on the screen. It will be noted that the screen, as shown on FIG. 3, shows only an arc of wheel 330, allowing the screen application to a) place additional apps on the wheel 330 and b) bring those additional apps into view on the displayed arc as the Apps Wheel 330 is rotated by the user. The user can click on any app icon that comes into view on the displayed arc. This design reduces the use of ‘drop down boxes’ and cleans up the site. This functionality of the Apps Wheel 330 enables use of the invention where the user connection 215 to the Internet is a touch screen device such as a smart phone or tablet.

When working with certain pages where plenty of room needs to be provided for the work space the Apps Wheel 330 will automatically shrink into its own easily visible icon on the page. The following additional functionalities are provided for Apps Wheel 330:
One click on the icon and the work is saved.
The Apps Wheel can be made to appear transparently onto the screen.
The visible arc of the Apps Wheel 330 shows the app icons most recently used.
Showing on the screen icons relevant to the app the user is currently working with.
If an app or home icon is selected that takes the user totally off the screen they are working with, the user will be prompted: “are you choosing to leave this screen”.
Display in the visible arc those apps most frequently used. For example, the visible arc shown for Apps Wheel 330 in FIG. 3 could indicate that the user most recently used the following apps: Friends 350; Settings 345; Employers 380; Inbox 340; Profile 370; Job Search 335; Pictures and Videos 390; Shopping 395; and Vouched4 360. Similarly, for the Ad and New Feed Wheel 310 in FIG. 3 could indicate that the following information was most recently supplied to the user: Weekly Job Feed 320; an ad 325 for a hot balloon trip; a new picture 315 from the Kruger company.

In addition, the Apps Wheel 330 will track every selection; time spent there, relation to other selections by the user, what apps are ignored, what apps are used most frequently, and other statistics about how the user uses apps on the Apps Wheel 330.

It should be noted that the wheel implementation described herein can support a plurality of wheels in a variety of implementations. In the preferred implementation, the endpoints of the visible arc are both on the left side of the screen. However, this is a design choice. It is also a preferred implementation to have a second wheel, such as the Ad and New Feed Wheel 310, available within a single screen icon, as shown in FIG. 3, where the dominant outer arc (Apps Wheel 330 as shown in FIG. 3) could be toggled between the two wheels. Alternatively, the subordinate inner arc could be replaced by a button for the second wheel, where clicking the button would place the second wheel in the dominant outer arc and the first wheel would be replaced by a button, thereby providing a toggle mechanism. These alternatives are also design choices, and any particular wheel can be implemented as a separate screen and icon. The location of apps on different wheels is controllable by the user by dragging and dropping of app icons from one wheel to another, allowing users to organize their apps.

### Profile App for Employees and Students

The Profile App 370 contains personal information, account settings, children, interests, personal goals, preferences and other settings, educational qualifications, and a place for uploading a resume. For the web profile, should the user select the option to publish their updates, Friends 350 and Contacts 233 can be updated. Also, a ‘Press Release’ type update can be made to the web showing all the member approved text the member wishes to be published to the other services (such as Google, Yahoo, MSN) so that they can be found and known by others. The Profile App 370 allows the user to build a public profile that will help members with reputation, including links on other services that will bring the web surfer back to the web site implementing the present invention.

Hiring entities can see only what the member wants them to see. Criteria that will be shown to the seeker include availability. If a member is currently employed and unavailable, a projected date of availability will be listed. If unavailable; the member can recommend up to three replacements candidates from his Contacts. Hiring entities will also see member ratings and the member resume. Optional items include: earnings/rate history; job role types (short term/long term/willing to relocate) that are acceptable to the member; profile picture; and references.

Photos can be uploaded—whatever the member would like to show. Members who work in media/advertising as models or graphic artist types—any artistic creation role would want to showcase their pictures. Vouched4 technology will take the members at their word that they obtained certain certificates and diplomas. However the technology will increase the scoring for a member if they get the certification or diploma verified by the issuing educational entity. Vouched4 will encourage all educational entities to generate a script that only the entity could produce which links back to their system showing the certificate or diploma is indeed valid.

Contacts App for Employee and Students

Members make Contacts by ‘friending’ other members and are encouraged to friend up to Contacts by requesting ‘friends’ to evaluate them within their industry. These evaluations in accordance with the invention will come from past or present co-workers in particular areas (e.g. sales, project managers, vetinarians, etc.). A stripped down version of the Category Matrix is utilized for the Contact Evaluations. Only a manager or director or supervisor can truly provide a ‘hiring’ type evaluation used for future employment but peer review is important. However, the number and interconnection among Contacts may say some additional things about the member that an evaluator would never feel comfortable speaking about, such as how well liked was the member while in the evaluator's employ. Having Contacts may show some things about the member not revealed by the formal evaluation.

The Contacts made by a member speaks to both members who have a Contact in common. The rankings of the Contacts for the member creates a group as well, and the group itself is ranked. The system limits member Contacts (e.g. twenty-five) so that the group rating means something. This will provide incentive for members to be selective about their choice of Contacts. Contacts are updated whenever another member they are Contacts with has an increase or decrease in their scoring from evaluations.

Positive evaluations help the ranking of the overall group—this fosters everyone rowing in the same direction—becoming an elite group. Elite groups command higher pay rates and benefits than lesser ranked groups. Negative evaluations can get a Contact disconnected by members. The system allows dropping and adding Contacts on a limited frequency (e.g. four times a year) so that groups will not game the system.

### Groups App for Employees and Students

Each user will be a member of a group decided by the industry group they base a career on (e.g. within the construction group there may be a project manager group, and within that group there are those with Class A licenses, etc.). Each user can be part of multiple groups which are within a larger overall group (e.g. a structural engineer group, as well as the higher level commercial construction project manager group). Groups are important because maximum exposure of the user/worker is a benefit here when being searched for by employers. Groups will be organized as a global group then by nation, then by region, then by state, then by city. Users can be members of as many groups that they can state they have qualifications for.

### Employers App for Employees and Students

An account for an employer is created once an employer provides an evaluation/assessment in response to a link emailed to the employer by the current or former employee from the Vouched4 system. The system will check to be sure that evaluation is sent an email address that has a domain matching the name of the company the user provided when they uploaded their resume into their profile. This provides credibility for the evaluations generated for the user.

The evaluation process requires that the member utilize the system's application that generates Vouched4 requests. The application will need the full name of the supervisor, manager, director, client, etc. The app requires the email address of the target evaluator, and the domain of the email address must be at the company so @pfizer.com or @homedepot.com no gmail/yahoo/Hotmail etc will work—the code generated by the site will not occur—it has to match the company named in the resume. Once all is accomplished at our site, and email is sent into the email account of the member for forwarding to the target evaluator. The evaluator creates an account by choosing their password now that they are at our site as a result of clicking the link emailed to them from the member. An email will be sent into the account with the company domain provided us by the member for proving the evaluator has access to an email account at the identified company. The evaluator clicks the link in their email and is activated at our site. The page that opens is now the evaluation form.

The entire assessment category matrix will be divided into three or four parts so as not to overwhelm the evaluator. At the bottom of the page a progress indicator will tell the evaluator how much of the task remains. When the evaluation is completed by the evaluator, the evaluator's company will then have access to the Vouched4 site to look for future employees, thus providing an incentive to complete the evaluation. An email is also generated to the evaluators corporate email account thanking them for their time, reassuring them they did a kind turn for someone, and invites them to become a member as well as an individual user. Reminder emails will be sent if the evaluation isn't completed or the evaluator didn't create an individual account. The activity of evaluators will be tracked by the automated system so as not to ever send more than a couple evaluation requests to the same evaluator in the same two week period.

When a member wants to apply to a job on a job board or via email the Vouched4 technology will generate a pdf of their profile with their evaluation scoring in tables at the top of the document and their resume to follow on. This will serve as a professional and standardized documentation on behalf of the person applying for the job. The Vouched4 system will monitor the success of responses from applications sent by the member.

Assessment Matrix

| | | | |
|---|---|---|---|
| COMMUNICATIONS | EXPERTISE | ATTITUDE | EXPERIENCE |
| Verbal - 1 on 1 | Able to lead - general | Lasting impression | Within a challenge |
| Verbal - in a group | Able to lead - problem | On target: with | Within a solution |
| Written - email | solving | accomplishment | Executing on solution |
| Written - a | Able to support - general | Approachable | JOB SAVVY |
| proposal | Able to support - | Off target result | Career progression |
| LISTENING | leadership | Friendly | Go getter |
| Understanding | Lead on solution analysis | With a mistake | Ambitious |
| Comprehension | Knowledge of subject | Accountability | Judgment |
| Accessible | matter | Owns the work: good | Team builder |
| ATTENDANCE | Self-starter | result | SOCIAL |
| Flexible with | Inspires others | Owns the work: bad result | Flexibility |
| shifting | SKILLSET | Helping others | Addressing others |
| requirements | Knowledge | Accommodates requests | Explaining situation |
| Beginning of job | Qualifications | Inside the team | Receiving feedback |
| daily | Knowledge brought: met | ETHICS | Giving critical feedback |
| Meetings | expectations | Truthful | ON JOB PERFORMANCE |
| Any prearranged | Knowledge brought: | Respectful: to people | Handling unexpected: |
| absence | beyond expectations | Respectful: of privacy | additional |
| General punctuality | | Respectful: of policy | Handling unexpected: |
| | | Compliant | shortage |
| | | Reliable | Handling role change: |
| | | PROFESSIONAL CONDUCT | around |
| | | Above and beyond | Handling role change: |
| | | BEHAVIOR SOCIAL | personal |
| | | | Handling change in scope |
| | | | Handling change in |
| | | | superior |
| | | | Handling change in |
| | | | management |
| | | | Dependable |

Evaluation Criteria

In the evaluation a past employer would score the individual on a numerical scale (e.g. 1 to 9) from ‘lacking’ to ‘excellent’ with a midpoint of ‘average’ on worker categories of: timeliness, responsibility, truthfulness, proficiency, expertise, subject matter knowledge, availability, communication, and attitude.

The individual after gathering a minimum of three evaluations can then be a fully activated member of the site. They can then use the site to back up their credibility with a ‘vouched for’ element when seeking their next place of employment.

The site will make enormous inter-connectivity among the members by; category of career specialties, location, seniority in career, specialty within a career category, member connected, company connected, industry group, connected.

The site offers the employing world the ability to locate/identify and immediately; review, select, negotiate, and hire people from a source of candidates who have been ‘vouched for’ by their past employers so to eliminate those who; aren't vouched for, or have reputations that cannot be considered upstanding.

It offers the working world the ability to cross over racial limitations restricting good workers exposure, or level of pay, highlights their abilities, loyalty to future by way of building a great reputation, and a place to illuminate among their future employers and their peers what they have accomplished, completed, conquered, and closed out.

From India to Russia to Brazil to Canada and Ireland to China, this site will download the working worlds' measurable criteria and present it in a meaningful way back to the world. From accountants to veterinarians and everything in between if you work for a living this site will consider you a future member.

Evaluation Process

Evaluations are sent by the system in three or four parts with many weeks between each request of the evaluator to complete them. Members will be required to provide the system an evaluation every 120 days, at the end of an employment period, or every 180 days if they are permanently employed. If the system notices an update in their work profile to show another job has been taken by the member it will request an evaluation from the past employer. A member will have sixty days to provide that evaluation. An element of system functionality is that the system tracks when a requested evaluation has been completed, and if an evaluation has not been completed by the evaluator the system prompts the member to send to an evaluation request to someone else if there has been no response within fifteen days. The system will send email reminders with continuously stronger urgings to the evaluator (e.g. “your past employee counts on you to spend two minutes processing this evaluation”).

If multiple attempts by the member have been made to multiple people at the former place of work they can obtain one from a different employer but there will be an asterisk by the evaluation once uploaded and will show none was provided by the actual company the member just separated from—their last place of employment. Vouched4 will urge that any employee agreement signed by the member include language like this example to try and preclude a non-responsive evaluator: “BE ADVISED, as a condition of my employment I require that my superiors respond to requests made by Vouched4. These requests will be in the form of an evaluation which can be filled in all at once or broken up into 3 parts. Each part will take about 2 minutes of my superior's time and upon my separation should this ever be the case, as part of my agreement to work I require a full evaluation for the Vouched4 system.”

Students

A similar approach is taken toward students, with appropriate modification of the evaluation algorithm to address the particular aspects of school performance of interest to higher levels of education, including an arrangement of evaluators that will include teachers, guidance counselors, mentors, coaches and others who are important for the performance of the student.

No longer will colleges be guessing about students and they can be compared to each other in a much more transparent manner, as well has the students having a target and plan to hit once they are Freshmen in high school. Colleges would be able to publish their minimum metrics based from our rating structures and adjust them for each year prior to the acceptance process. Students would write their essays for entrance consideration on the site. If they played sports; statistics would be included as colleges are looking for scholarships. Chess club, whatever specialties the student chose to put time and effort into will be considered in the algorithm for this individual. Electronic encrypted secure links to all colleges around the world so that submissions may be made along with their uploaded application, their Vouched4 profile sent electronically to every school they want to apply for.

### Vouched App for Employees and Students

There are no requests in the evaluations for written explanation as answers to the questions or items for rating 1 thru 9. There is a statement in the form of a positively framed request and the fill-in-the-dot bar below each question. Since the feedback is numeric it can be equated to a real value and can present business intelligence from the data we create. A member will end up with an overall score from the three minimum evaluations returned to them by their past employers

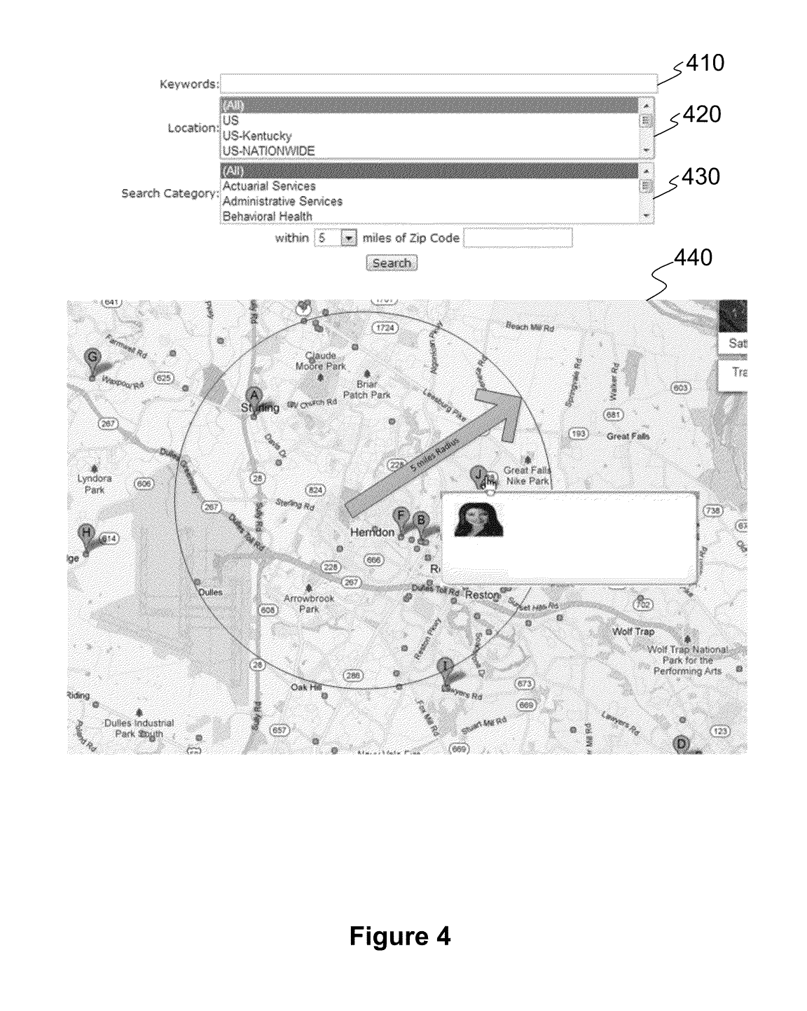

As described more below each career will have the algorithm geared toward what is most important about that industry group. Hiring personnel will get to see the overall score—the algorithmic calculated averages of each category, but not who evaluated the member, and not the individual scores of any individual evaluator. Once the hiring entity drills down to the specific categories they are seeking they will see ‘groups’ of people that have the credentials and qualifications they are requiring. They will be looking at icons for each group chosen by the group via online vote so each icon will be unique as often as possible (the system will prevent the same icon being used in the same regions). The icons will appear on a map as illustrated by item 440 on FIG. 4 showing their location, for example, in relation to the hiring entity's facility. One would see an icon for each individual—behind the icon indicative of the group they are in and the numeric overall rating of that group. When the seeker hovers their mouse over any of the icons a pop up micro window appears with options to select a members profile or to select group members. There will also be options to flag a member or contact a member.
Members Profile: select this and up comes a screen on the side of the page showing details and more options. The vicinity map does not disappear.
Group Members: select this an up comes a transparent page showing a digest of each member in the group, with further options to select particular group members. The vicinity map will move in behind an icon in the top right corner of the page—the search criteria will not be lost—one click and the map is back. If the seeker wants to leave the page on the group that is being viewed and go back to the map or anywhere else in the site the seeker will be prompted to save the group or let it go. If the group is saved an icon of the group is positioned by the icon for the vicinity map which creates a link between the group and the map—a product of the research done by the seeker. If the seeker wants to compare groups an option is selected to do so using common criteria.
‘Flag’ Member: this option would store the member in the seeker's account under the position criteria the seeker was utilizing for this search; more than one member might be so flagged, to accommodate those seeking multiple candidates for a position or positions.
Contact Member: this option would be implemented by whatever method is made available by the member in the member profile. This could include a Vouched4 web conference, an Instant Messenger if the member is online, email (by clicking the email icon so the email address stays private for the member), or phone (by clicking the icon for phone a call is run through the seeker's headset through Vouched4 telephony service or a similar service such as Skype). The phone number itself stays private and is not available to the seeker unless the member profile makes the phone number available.

### Rating of User's Performance

Algorithms to weight the evaluation criteria are essential to quantify the ratings provided by the evaluator in combination with rating of the industry group the member belongs to. For example, a customer service rep would have an algorithm with heavier weighting on Attitude and less on Attendance, whereas a database administrator would weight these criteria in the opposite order. For the DBA, attitude is still important but having their presence at the facility they manage is essential to those who depend on fixes, reports, and user community support provided by the DBA.

If the sum total of weights over all the criteria categories is 100, then the six criteria categories of communications, expertise, attitude, experience, attendance and skillset would each receive an equal weight of 100/6 or 16.6. A weighting algorithm for the criteria <communications, expertise, attitude, experience, attendance, skillset> for a Customer Service Rep might be <30, 15, 20, 12, 11.5, 11.5> for a Database Administrator might be <12, 18, 10, 30, 10, 20>. So as the scores are entered into the evaluation the impact of each category is affected by the score and the weight given to the category. This works to identify for a particular job what each member excels in and could work to improve. This gives insight at a more granular level to the employer looking over hiring options. At a less granular level, these weights multiplied by the numerical rating for the corresponding criteria could be then added together and the sum is divided by 100 to obtain a simple linear normalized average rating.

It may be appropriate to develop more sophisticated and even non-linear weighting algorithms, depending on the job performance requirements and other factors such as: tenure in the career with specialties, knowledge from other backgrounds, military experience, awards won, degree of levels of certification, and depth at education.

One of the functions of the invention implemented on the Vouched4 web site is to provide users with opportunity and motivation to improve their scores in the Assessment Matrix. Toward this end a user can take an aptitude test on Vouched4 website, provide feedback to colleagues, take training classes, and participate in volunteer programs.

### Shopping App for Employees and Students

The web site can adopt apps that attract users to the site even though the app is not directly involved in connecting employees with employers or connecting students with learning opportunities. User already supplies credit card information while registering into vouched4 account. So, it is feasible to add a shopping app to the apps wheel. Such an application could be implemented as a full shopping website where customers can shop and buy products, or as a forum where users can share shopping related information.

### My Ads App for Employees and Students

In the preferred implementation of the invention the screen and icon housing the Apps Wheel 330 will also house the Ad and New Feed Wheel 310 as shown in FIG. 3. The ads selected for viewing by a member on the Ad and New Feed Wheel 310 will be chosen based on information the member has provided Vouched4, for example, in the member Profile.

### Workforce Search Features and Talent Pool Features for Employers

A typical application for access by employers to a talent pool of qualified employees is shown in FIG. 4. A search may be conducted by any combination of keywords 410, location 420 and job search category 430. The location 420 may include options to select ‘local’ or ‘outsourced’ or ‘global’. ‘Global’ might be fitting because the position requires someone in a very specialized role/top of their field/etc. ‘Outsourced’ means they are hiring someone that won't be on premise.

Then the search process narrows down to exactly what they are looking for in a role to hire by one group focused on one specialty or maybe the role requires multiple specialties (e.g. someone who builds kitchens and sunrooms; an IT pro that knows PeopleSoft and Oracle database 11g; a veterinarian that knows angus and cats; a doctor who knows Neurology and vertebrae fractures versus seizures caused by Epilepsy).

Hiring commences when the hiring entity contacts the member via the site, which automatically sends alerts via text and email to the member. The member will be able to see, without charge, whoever views their profile. Video conferencing provided through the Vouched4 system can be used by the hiring entity and the member to discuss the position, arrange for or conduct an interview, or otherwise communicate.

Members can use the app to search for others in their industry or specialty.

### Business Intelligence Reports for Employers

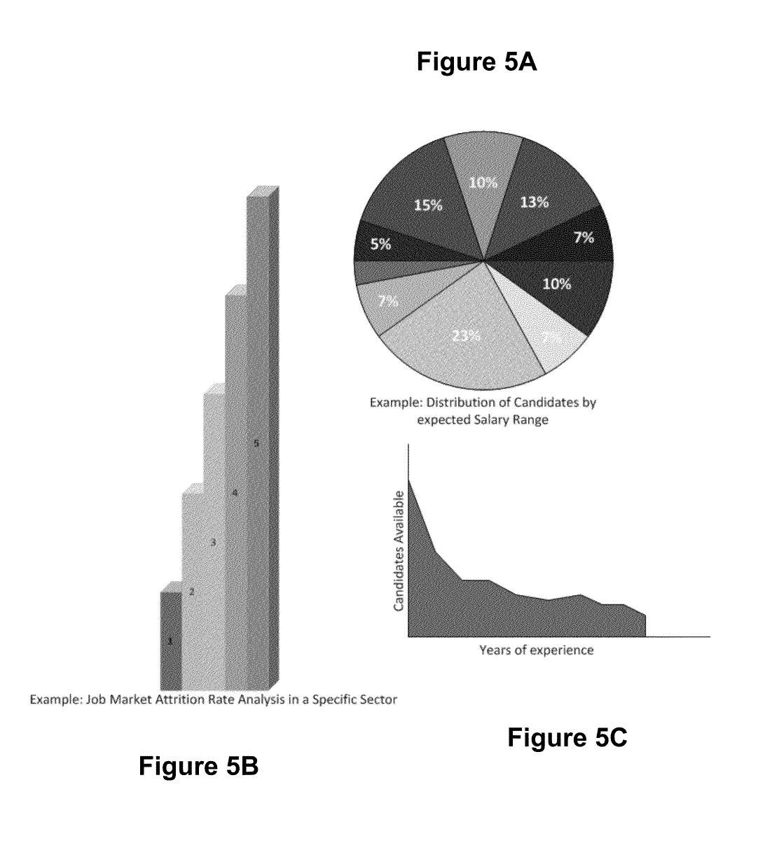

Business intelligence reports provided through the Vouched4 system can be viewed by HR on their dashboard. This will add value to the Vouched4 application. FIGS. 5A, 5B and 5C illustrate the types of information display that may be used to provide these reports. FIG. 5A is a pie chart, which could be used to show distribution of candidates by expected salary range. FIG. 5B is a bar chart, which could be used to a show job market attrition rate analysis in a specific sector. FIG. 5C is graph, which could be used to plot the number of candidates available by years of experience.

Using such displays an application provided within the system to employers can provide an Activity Map that gives a global to granular look at the world wide job activity picture. Similarly members can view all the activities in their group, activities in other groups, and activities in their industry as a whole. Members can find increased activity by those with roles similar to theirs and identify enhancements to their skill sets that will differentiate them from others. Members are able to drill down through the available member metrics to see the data from a variety of perspectives. Similarly, businesses can use this facility to see hiring and outsourcing trends by region, all without disclosing the company's own hiring data.

While the invention has been described in terms of preferred embodiments, those skilled in the art will recognize that the invention can be practiced with modification within the spirit and scope of the appended claims.

Having thus described my invention, what I claim as new and desire to secure by Letters Patent is as follows:

1. A method for using verified assessments of employee capabilities in hiring decisions, comprising:
obtaining verified assessments of employee capabilities with respect to a plurality of performance criteria;
weighting the performance criteria in accordance with a job description group to which the employee belongs;
applying the weighted performance criteria to the verified assessments;
rating the group; and
making a hiring decision by combining the applied weighted performance criteria and the group rating.

2. A method as in claim 1, wherein the verified assessment is made by a prior employer by applying a numerical scale to criteria on an assessment matrix.

3. A method as in claim 2, wherein the verified assessment is completed in several parts over several weeks.

4. A method as in claim 3, wherein a reminder is sent to an evaluator who has not completed an assessment part as scheduled.

5. A method as in claim 1, wherein the performance criteria are adapted to the job description of a student and the hiring decision is acceptance at a higher level institution of learning.

6. A system for using verified assessments of employee capabilities in hiring decisions, comprising:
means for obtaining verified assessments of employee capabilities with respect to a plurality of performance criteria;
means for weighting the performance criteria in accordance with a job description group to which the employee belongs;
means for applying the weighted performance criteria to the verified assessments;
means for rating the group; and
means for making a hiring decision by combining the applied weighted performance criteria and the group rating.

7. A system as in claim 6, wherein the verified assessment is made by a prior employer by applying a numerical scale to criteria on an assessment matrix.

8. A system as in claim 7, wherein the verified assessment is completed in several parts over several weeks.

9. A system as in claim 8, wherein a reminder is sent to an evaluator who has not completed an assessment part as scheduled.

10. A system as in claim 6, wherein the performance criteria are adapted to the job description of a student and the hiring decision is acceptance at a higher level institution of learning.

11. A method for displaying computer applications to a user, comprising:
arranging the computer applications as icons along a perimeter of a wheel structure;
displaying an arc of the perimeter, thereby exposing a subset of the applications;
rotating the wheel structure, thereby exposing additional applications within the displayed arc; and
rearranging the icons so that those applications most often used are in the displayed arc.

12. A method as in claim 11, wherein there are first and second wheel structures and corresponding displayed arcs.

13. A method as is claim 12, wherein the first and second wheel structures are toggled in the same display, replacing each other by pressing a button.

14. A method as in claim 11, wherein the wheel structure reduces to an icon when a selected application requires room on the display.

15. A method as claim 12, wherein the first and second wheel structures are in the same display, the first wheel structure being dominant and the second wheel structure being displayed within the arc of the first wheel structure.

16. A system for displaying computer applications to a user, comprising:
means for arranging the computer applications as icons along a perimeter of a wheel structure;
means for displaying an arc of the perimeter, thereby exposing a subset of the applications;
means for rotating the wheel structure, thereby exposing additional applications within the displayed arc; and
rearranging the icons so that those applications most often used are in the displayed arc.

17. A system as in claim 16, wherein there are first and second wheel structures and corresponding displayed arcs.

18. A system as is claim 17, wherein the first and second wheel structures are toggled in the same display, replacing each other by pressing a button.

19. A system as in claim 16, wherein the wheel structure reduces to an icon when a selected application requires room on the display.

20. A system as claim 17, wherein the first and second wheel structures are in the same display, the first wheel structure being dominant and the second wheel structure being displayed within the arc of the first wheel structure.
